(19) United States
(12) Patent Application Publication
(10) Pub. No.: US 2007/0151815 A1
(43) Pub. Date: Jul. 5, 2007

(54) Self-boosting electromechanical friction brake

(76) Inventors: Dietmar Baumann, Hemmingen (DE); Dirk Hofmann, Ludwigsburg (DE); Herbert Vollert, Vaihingen/Enz (DE); Willi Nagel, Remseck/Hochdorf (DE); Andreas Henke, Diemelstadt (DE); Bernd Goetzelmann, Sindelfingen (DE); Bertram Foitzik, Am Wasserfall (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/584,195

(22) PCT Filed: Nov. 17, 2004
(86) PCT No.: PCT/EP04/52994

§ 371 Date: Jun. 23, 2006

(30) Foreign Application Priority Data
Dec. 24, 2003 (DE) 103 61 264.5

(51) Int. Cl. F16D 55/46

(52) U.S. Cl. 188/72.2

(57) ABSTRACT

The invention relates to a self-boosting electromechanical friction brake, having a friction brake lining which is displaceable for actuation in the direction of rotation of a brake disk and is braced on a ramp, via a roller body. When the friction brake is actuated, a rotating brake disk exerts a frictional force on the friction brake lining pressed against it, which urges the friction brake lining in the direction of an increasingly narrower gap between the ramp and the brake disk and as a result exerts a contact pressure in addition to a contact pressure exerted by an actuation device. The self-boosting action is attained as a result. To prevent the roller body from sliding on the ramp, the invention provides a positive controller, for instance with a gear wheel on the roller body that meshes with racks.

### PRIOR ART

The invention relates to a self-boosting electromechanical friction brake having the characteristics of the preamble to claim 1.

One such friction brake is known from International Patent Disclosure WO 03/056204 A1. The known friction brake is embodied as a disk brake. It has a friction brake lining, which for braking can be pressed by an electromechanical actuation device against a brake body to be braked; in the case of a disk brake, the brake body is a brake disk. The electromechanical actuation device of the known friction brake has an electric motor, a step-down gear, and a screw drive as a rotation/translation conversion gear. With the actuation device, the friction brake lining can be moved transversely or at an angle obliquely to the brake disk and thus pressed against it. The construction of the electromechanical actuation device can differ from the construction described here.

To attain self-boosting, the known friction brake has a ramp mechanism, with a ramp extending at an angle to the brake disk, on which ramp the friction brake lining is braced upon being pressed against the brake disk. If in braking the friction brake lining is pressed against the rotating brake disk, then the brake disk exerts a frictional force on the friction brake lining, which urges the friction brake lining in the direction of an increasingly narrow wedge-shaped gap between the ramp that supports the friction brake lining and the brake disk. The bracing of the friction brake lining on the ramp, extending obliquely to the brake disk, of the ramp mechanism exerts a force on the friction brake lining that has a force component transverse to the brake disk. This force component transverse to the brake disk is a contact pressure, which presses the friction brake lining against the brake disk. The contact pressure exerted by the ramp mechanism increases a contact pressure exerted by the electromechanical actuation device and thus increases a braking force of the friction brake. This increasing of the contact pressure and braking force is called self boosting.

An angle at which the ramp of the ramp mechanism extends relative to the brake disk can change over the course of the ramp. A special case or limit case of a ramp mechanism is a wedge mechanism in which the angle at which the ramp extends to the brake disk is constant over the course of the ramp. In this case, the ramp is called a wedge. A plurality of ramp mechanisms may be provided, which are distributed over a back side of the friction brake lining facing away from the brake disk and that brace the friction brake lining jointly.

In the known friction brake, balls or rollers are provided as roller bodies, by way of which the friction brake lining is braced on the ramp and which reduce friction upon displacement of the friction brake lining along the ramp. The roller bodies in the known friction brake roll on raceways that are provided on a back side, facing away from the brake disk, of the friction brake lining and on an abutment plate facing toward the friction brake lining. The raceways extend in the displacement direction of the friction brake lining and are at their lowest point at the center of their length; their depth decreases from the center of the length in both directions. As a result, the raceways form the ramp or ramps of the ramp mechanism. The raceways are mounted in sunken fashion in the back side of the friction brake lining and in the abutment plate; they guide the roller bodies, and via the roller bodies the friction brake lining, transversely to the displacement direction.

The self-boosting electromechanical friction brake has been described above in terms of a disk brake, because it can be explained clearly in terms of a disk brake since known friction brakes of this kind are predominantly embodied as disk brakes, and because even the friction brake named as prior art is a disk brake. This does not preclude the implementation of the invention in other types of brake.

If the friction brake lining of the known friction brake is pushed back and forth for braking and for releasing the brake, the roller bodies ideally roll along the raceways, and they are in their original position when the friction brake lining is also in its original position again. This is true, in the strict sense, only if brake lining wear is ignored, or in a friction brake with readjustment for wear. However, it cannot be precluded that the roller bodies will not merely roll but will also slide on their raceways when the friction brake lining is pushed back and forth. In that case, the roller bodies no longer return to their original position. When the friction brake lining has been pushed back and forth many times, the roller bodies can “wander away” farther and farther from their outset position.

### SUMMARY AND ADVANTAGE OF THE INVENTION

The friction brake of the invention having the characteristics of claim 1 has a positive controller for the roller bodies, which prevents sliding of the roller bodies on the raceways, or at least limits it such that the roller bodies do not leave their raceways. The invention prevents the roller bodies from being able to move arbitrarily far away from their outset position and preferably causes the roller bodies to return to their outset position when the friction brake lining is thrust back into its outset position. A gradual “wandering” of the roller bodies toward the ends of their raceways or out of the raceways when the friction brake is actuated many times is avoided.

The dependent claims have advantageous features and refinements of the invention defined by claim 1 as their subject.

As a simple possibility for a positive controller, claim 2 provides an end stop for the roller bodies, which restricts a travel of the roller bodies. This feature of the invention is especially suitable for friction brakes with self-boosting in only one direction of rotation of the brake body. The end stop, or two end stops, can be mounted on the end of the raceway or raceways, respectively, so that the roller body is moved in compulsory fashion back into its outset position when the friction brake lining is thrust back into its outset position. The roller body as a result necessarily occupies its outset position at the onset of each brake actuation. It is an advantage that the friction brake is released when a roller body is moved back into its outset position from the end stop. That is, no contact pressures, or at most only slight contact pressures make sliding of the roller body on the raceways for restoration to the outset position difficult are operative. However, an end stop may also be located at some other point, such as a different end of the raceway of the roller body. It is understood that braking is also possible for the opposite direction of rotation of the brake body, although then without self boosting or even with self-attenuation. The end stop need not come directly into contact with the roller body; for instance, it may cooperate with a roller body cage instead.

Claim 4 contemplates a forced motion of the roller bodies with the displacement of the friction brake lining upon actuation of the friction brake. The roller bodies are accordingly moved for instance at half the speed and for half the distance as the friction brake lining, compared to a purely rolling motion without sliding. In this feature of the invention, the applicable position of the roller bodies is determined in compulsory and unambiguous fashion by the position of the friction brake lining.

One possibility for such a positive controller is as in claim 5 to provide a gear wheel on the roller body, which meshes with a rack on the friction brake lining and/or on the ramp.

Claim 7 provides a roller body cage, which keeps all or some of the roller bodies of the friction brake at their spacing from one another. The roller body cage, which has the same function as a ball cage of a ball bearing, moves the roller bodies with one another in compulsory fashion and prevents a displacement of one roller body or individual roller bodies relative to the other roller bodies. In this case, one positive controller of a roller body suffices for all the roller bodies connected to the roller body cage.

The positive controller may engage one or more roller bodies directly. Claim 8 is directed to the possibility that the positive controller engages the roller body cage and by way of it indirectly moves the roller bodies in compulsory fashion. For instance, the gear wheel that meshes with the rack is mounted on the roller body cage.

Claim 9 provides that at least one roller body guides the friction brake lining transversely to its displacement direction in a statically determined way. The phrase “transversely to the displacement direction” means guidance of the friction brake lining in a plane parallel to a brake disk, or radially to an axis of rotation of the brake disk. This feature avoids play of the friction brake lining transversely to its displacement direction, in a plane parallel to the brake disk. A static overdeterminedness of the bearing and guidance of the friction brake lining transversely to its displacement direction, which because of manufacturing tolerances can cause mechanical stresses and increased wear, is also avoided. This feature of the invention has the advantage of making only slight demands in terms of manufacturing tolerances.

A refinement according to claim 10 provides that two roller bodies guide the friction brake lining transversely to its displacement direction in a statically determined way. As a result, in addition to the play-free guidance of the friction brake lining transversely to its displacement direction, a rotation of the friction brake lining about an imaginary axis that penetrates the friction brake lining at a right angle is avoided. A third roller body and optionally further roller bodies have no guidance function for the friction brake lining transversely to its displacement direction, in order to avoid a static overdeterminedness of the transverse guidance of the friction brake lining, or in other words radially to a brake disk.

If the roller bodies that guide the roller body transversely to its displacement direction in a statically determined way are balls, claim 10 provides for a four-point bearing of the friction brake lining by the balls. This means that the balls, in each spherical channel in which they rest, rest on the spherical channel at two points, one on each side of an imaginary longitudinal center line of the spherical channel. That is, the balls rest in the two spherical channels at a total of four points. The desired two-point contact in each spherical channel can be attained by means of a rounding, of other than circular shape, of the spherical channel, or for instance by means of a prismatic shape of the spherical channels.

If cylindrical or conical rollers are used as roller bodies, then in accordance with claim 12 they are disposed with an inclination transversely to the displacement direction of the friction brake lining, in order to accomplish the desired statically determined guidance of the friction brake lining transversely to its displacement direction.

The features of the invention defined by claims 9 through 12 can be realized in a friction brake of the invention jointly with or independently of the positive controller of the roller bodies recited in claims 1 through 8.

### DRAWING

The invention is described below in terms of exemplary embodiments shown in the drawing. Shown are:

FIG. 1, a schematic perspective view of a self-boosting electromechanical friction brake;

FIGS. 2 through 8, various possible designs of roller bearings of a friction brake lining of the friction brake according to the invention shown in FIG. 1.

The drawings should be understood as schematic, simplified illustrations.

### DESCRIPTION OF THE EXEMPLARY EMBODIMENT

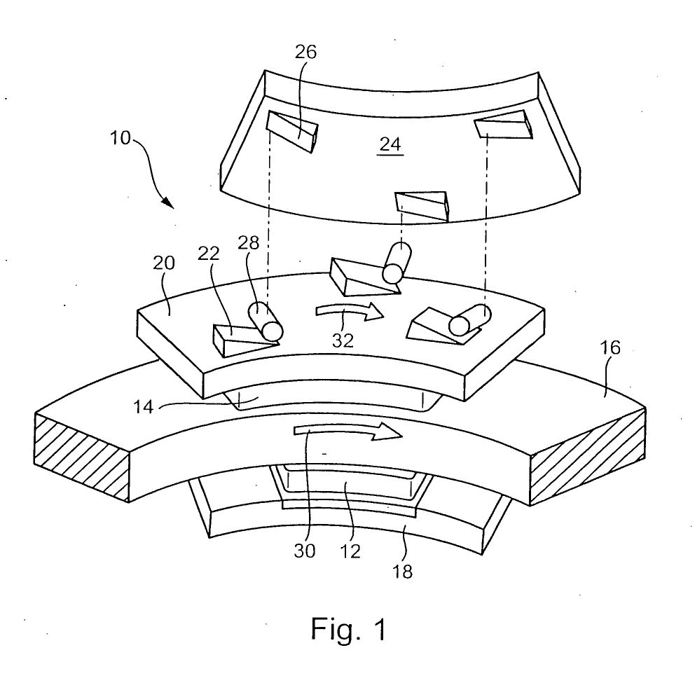

FIG. 1 schematically shows a self-boosting electromechanical friction brake 10, which is embodied as a disk brake. The friction brake 10 has two friction brake linings 12, 14, which are located one on either side of a brake disk 16. One of the two friction brake linings 12 rests firmly, that is, immovably, in a brake caliper 18. This friction brake lining 12 will hereinafter be called the fixed friction brake lining 12. Of the brake caliper 18, only a part located below the brake disk 16 in terms of the drawing is shown, because a part of the brake caliper 18 located above the brake disk 16 would conceal the essential parts of the friction brake 10. The brake caliper 18 fits as usual over the brake disk 16 outside the circumference of the latter.

The other friction brake lining 14 is movable in a direction of rotation and transversely to the brake disk 16. The phrase “in the direction of rotation of the brake disk 16” means that the movable friction brake lining 14 is rotatable about an imaginary axis, which coincides at least approximately with an axis of rotation of the brake disk 16. In principle, a displaceability of the movable friction brake lining 14 in a tangent or secant direction to the brake disk 16 is also possible. The motion of the friction brake lining 14 for actuating the friction brake 10 is effected with an electromechanical actuation device, which is not shown, for the sake of clarity in the drawing. Such actuation devices are familiar from the prior art, in various constructions, to one skilled in the art, and since they do not form the actual subject of the invention, they will not be described in detail here.

The friction brake lining 14 is connected as usual fixedly and nondetachably to a brake lining holder plate 20, which on their back side facing away from the brake disk 16 have ramps 22, which extend in the direction of rotation of the brake disk 16, or in other words in the displacement direction of the friction brake lining 14. On a front side of an abutment plate 24, oriented toward the brake disk 16, there are ramps 26, complementary to the ramps 22 of the brake lining holder plate 20, on which the ramps 22 of the friction brake lining 14 are braced via roller bodies 28. The roller bodies 28 are located between the ramps 22 of the friction brake lining 14 and the ramps 26 of the abutment plate 24; the roller bodies 28 roll on the ramps 22, 26. The roller bodies serve to reduce friction. In FIG. 1, the roller bodies are cylindrical rollers, but conical rollers, balls, or other roller bodies may be used instead.

The abutment plate 24 is approximately coincident with the brake lining holder plate 20, on the back side of that plate facing away from the brake disk 16. In FIG. 1, the abutment plate 24 is shown hinged upward, to make the ramps 22, 26 and the roller bodies 28 visible. In actuality, the abutment plate 24 is located parallel to the friction brake linings 12, 14 of the brake disk 16 and the brake lining holder plate 20. The abutment plate 24 is located fixedly, that is, immovably, in the part of the brake caliper 18, not shown, that fits over the brake lining holder plate 20 on its back side facing away from the brake disk 16. This part of the brake caliper 18 that is not shown is located above the brake disk 16 and above the brake lining holder plate 20 in FIG. 1. The brake caliper 18 is embodied as a so-called floating caliper; that is, it is displaceable transversely to the brake disk 16. When the movable friction brake lining 14 is pressed against the brake disk 16, the brake caliper 18 is displaced transversely to the brake disk 16 and presses the fixed friction brake lining 12 against the other side of the brake disk 16, so that the brake disk 16 is braked by both friction brake linings 12, 14.

For actuating the friction brake 10, the movable friction brake lining 14 is displaced in the direction of rotation of the brake disk 16. The direction of rotation of the brake disk 16 is represented in FIG. 1 by the arrow 30, and the displacement direction of the friction brake lining 14 is represented by the arrow 32 on the brake lining holder plate 20. Upon the motion of the friction brake lining 14 in the direction of rotation 30 of the brake disk 16, the roller bodies 28 roll on the ramps 22, 26. Because of the rise of the ramps 22, 26, upon the motion in the direction of rotation of the brake disk 16 the friction brake lining 14 is moved transversely toward the brake disk 16 and pressed against it. The brake disk 16 is braked. The rotating brake disk 16 exerts a frictional force in the direction of rotation on the friction brake lining 14 pressed against it, and this force urges the friction brake lining 14 in the direction of rotation 30 of the brake disk 16 and thus in its direction of motion 32. By way of the bracing on the ramps 22, 26, the action on the friction brake lining 14 along with the frictional force in the direction of rotation 30 of the brake disk 16 brings about a supporting force that has a component transversely to the brake disk 16. This force component transversely to the brake disk 16 forms a contact pressure, which in addition to a contact pressure exerted by the actuation device presses against the brake disk 16. The braking force of the friction brake 10 is boosted as a result.

The ramps 22, 26 extend at what is typically an acute ramp angle to the brake disk 16. The ramp angle may vary over the course of the ramps 22, 26, or in other words in their longitudinal direction. If the ramp angle is constant over the length of the ramps 22, 26, the ramps also called wedges. The ramps 22, 26 form a ramp mechanism, which brings about the self boosting of the friction brake 10.

In the exemplary embodiment shown, three ramps 22 are disposed on the brake lining holder plate 20, and three complementary ramps 26 are disposed on the abutment plate 24. This produces a statically determined bracing of the friction brake lining 14. A statically overdetermined bracing with more than three pairs of ramps 22, 26 is conceivable. Fewer than three pairs of ramps 22, 26 are also possible, for instance if two pairs of ramps extend over a width of the brake lining holder plate 20 or if one pair of ramps extends or a large proportion of the surface area of the friction brake lining holder plate 20 (not shown).

In the exemplary embodiment shown in FIG. 1, the ramps 22, 26 rise in only one direction of rotation 30 of the brake disk 16; that is, the friction brake 10 has self boosting only for the direction of rotation of the brake disk 16 represented by the arrow 30. In the opposite direction of rotation of the brake disk 16, no self boosting takes place. To attain self boosting for the opposite direction of rotation of the brake disk 16 as well, ramps may be provided (not shown) that rise in the opposite direction. By means of different ramp angles, various magnitudes of self boosting can be attained in the two direction of rotations of the brake disk 16, or in other words for travel forward and in reverse.

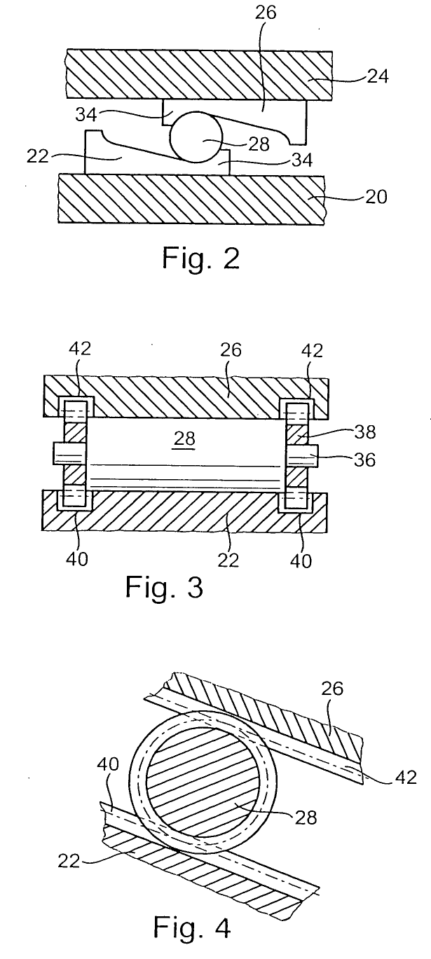

Only in the theoretical ideal case do the roller bodies 28 execute solely a rolling motion on the ramps 22, 26. In practice, it must be expected that the roller bodies 28, on the motion of the friction brake lining 14 back and forth for actuating and releasing the friction brake 10, will not solely roll on the ramps 22, 26 but will also slide on them. Over time, this can lead to “wandering” of the roller bodies 28; that is, after many motions of the friction brake lining 14 back and forth, the roller bodies 28 are no longer located in their original outset position at the beginning of the ramps 22, 26. The invention therefore provides a positive controller for the roller bodies 28, for which exemplary embodiments are shown in FIGS. 2 through 6 and are described below.

FIG. 2 shows a detail of the friction brake 10 of FIG. 1 in the region of one pair of ramps 22, 26. Fragments of the brake lining holder plate 20 and of the abutment plate 24 can be seen. The ramps 22, 26 have end stops 34 on both ends. The end stops 34 form a positive controller for the roller bodies 28; they prevent the roller bodies 28 from being able to leave the ramps 22, 26.

Another exemplary embodiment of a positive controller of the invention is shown in FIGS. 3 and 4; FIG. 3 shows an elevation view and FIG. 4 a cross section of one of the roller bodies 28. The roller body 28 has pegs 36 on both ends, on which pegs gear wheels 38 are rotatably mounted. The ramps 22, 26 on the brake lining holder plate 20 and on the abutment plate 24 are provided with racks 40, 42, which extend on both sides of the ramps 22, 26 parallel to the ramps 22, 26 and with the ramp angle as the ramps 22, 26. The gear wheels 38 of the roller bodies 28 mesh with the racks 40, 42. The gear wheels 38 that mesh with the racks 40, 42 form a positive controller of the roller bodies 28, which compel a purely rolling motion of the roller bodies 28 on the ramps 22, 26 and prevent sliding.

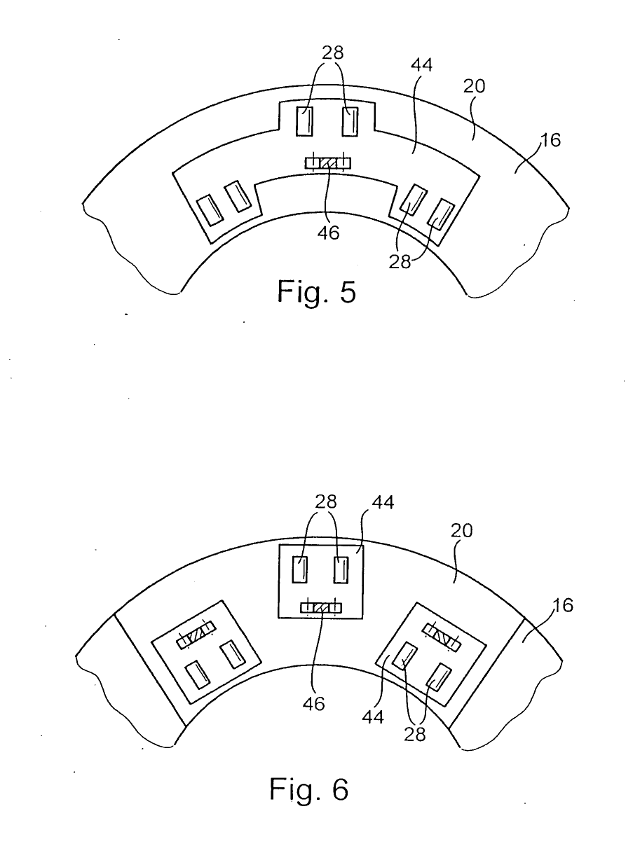

According to the invention, each roller body 28 may be provided with its own positive controller. FIGS. 5 and 6 show possible ways of combining several or all the roller bodies 28 in groups and to provide a common positive controller for all of them. FIGS. 5 and 6 show an elevation view of the back side, facing away from the brake disk 16, of the brake lining holder plate 20; the ramps 22 are hidden and therefore not visible. In a distinction from FIG. 1, in FIGS. 5 and 6 two roller bodies 28 each are shown. In the exemplary embodiment of the invention shown in FIG. 5, the friction brake 10 has a roller body cage 44. This is a sheet-metal part, which is embodied similarly to a ball cage of a ball bearing and which has the same function, namely to keep the roller bodies 28 in their spacing and position relative to one another. The roller bodies 28 rest rotatably in recesses in the roller body cage 44; accordingly, they can move only jointly. The positive control can be effected at one or more roller bodies 28, as shown in FIGS. 3 and 4; because of the roller body cage 44, a positive controller at one roller body 28 is sufficient. Alternatively, in FIG. 5, a gear wheel 46 supported rotatably in the roller body cage 44 is provided, which meshes with racks, not visible in FIG. 5, like the racks 40, 42 shown in FIGS. 3 and 4. Once again, the result is a positive control of all the roller bodies 28.

In FIG. 6, the two roller bodies 28, which are located on one ramp 22, are combined into a group with a roller body cage 44. The positive control is effected at each roller body cage 44, as described for FIG. 5, with a gear wheel 46 that meshes with racks that correspond to the racks 40, 42 shown in FIGS. 3 and 4. Once again, the result is a positive control of each roller body 28, which compels rolling of the roller bodies 28 on the ramps 22, 26 and prevents sliding.

To guide the friction brake lining 14 transversely to its displacement direction, it is known in the prior art to use balls as roller bodies 28, which are mounted in groovelike ball races in the brake lining holder plate 20 and in the abutment plate 24. By means of a greater depth of the ball races at the middle and ball races that become shallower toward their ends, the ramp effect is achieved. With cylindrical or conical rollers as well, the desired guidance of the friction brake lining 14 transversely to its displacement direction can be achieved, if ramplike raceways have raised edges, which guide the rollers on the face ends of the rollers. Both possibilities are disclosed in WO 03/056204 discussed at the outset. When three or more roller bodies 28 are used, they have the disadvantage of a static overdeterminedness of the guidance of the movable friction brake lining 14 transversely to its displacement direction, or in other words radially to an axis of rotation of the brake disk 16. This necessitates high-precision manufacture, in order to achieve low tolerances, and leads to increased wear.

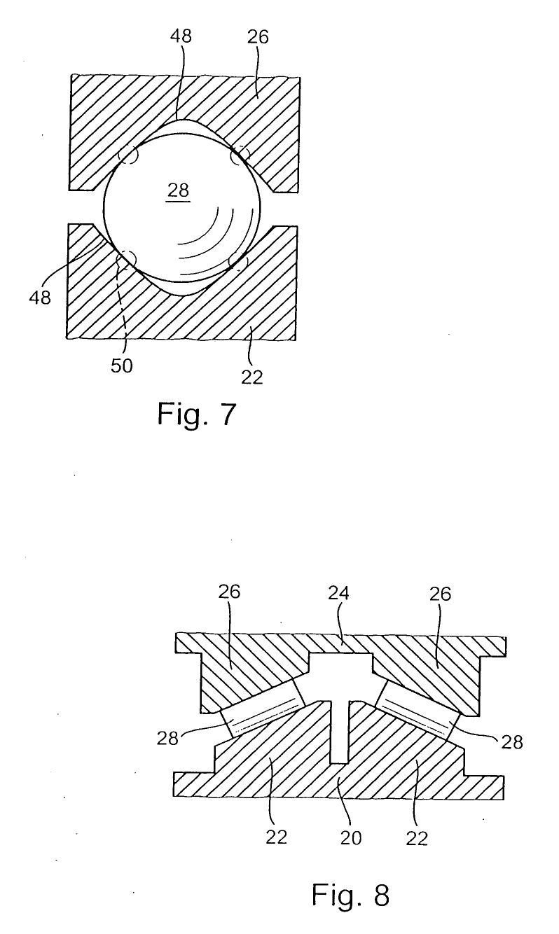

For guiding the movable friction brake lining 14 transversely to its displacement direction, one exemplary embodiment of the invention has the ball guide, shown in FIG. 7, with a ball as the roller body 28. The ball 28 rolls in spherical channels 48, which are mounted in the ramps 22, 26 of the brake lining holder plate 20 and of the abutment plate 24. The ball bearing is embodied as a so-called four-point bearing; that is, the spherical channels 48 do not have a circular cross section but instead have a cross section in which the ball 28 in each spherical channel 48 contacts two points, one on each side laterally beside a longitudinal center of the spherical channels 48. The contact points are represented by circles 50 in FIG. 7. The spherical channels 48 may, instead of the curved but not circular cross section shown in FIG. 7, have a prismatic shape (not shown). The four-point bearing brings about exact transverse guidance of the friction brake lining 14, even when a shear force is operative, and nevertheless makes only slight demands in terms of manufacturing precision. To avoid a static overdeterminedness of the guidance in the transverse direction, only two of the roller bearings, for instance the radially inner roller bearings in FIG. 1, located on both ends of the brake lining holder plate 20, have the four-point bearing shown in FIG. 7. The third and optionally further roller bearings may for instance be cylindrical rollers without guidance, or with play in the transverse direction.

Another exemplary embodiment of a statically determined guidance transversely to the displacement direction of the movable friction brake lining 14 is shown in FIG. 8. FIG. 8 shows a section through a radially inner roller body 28 of FIG. 1, and through the radially outer roller body, located in the middle of the friction brake lining holder plate. As the roller bodies 28 here, rollers are used which are inclined obliquely. Roller bodies 28 located on the outside, that is, roller bodies 28 located in the middle in FIG. 1, are obliquely inclined oppositely to the inner roller bodies 28, in order to achieve the desired guidance of the movable friction brake lining 14 transversely to its displacement direction. The ramps 22, 26 also have the transverse inclination. The transverse inclination of the roller bodies 28 varies, in order to keep the stress on them the same. The inclination of the radially outer, single roller body 28 is greater than the inclination of the two radially inner roller bodies.

1-15. (canceled)

16. A self-boosting electromechanical friction brake, comprising
a friction brake lining,
an electromechanical actuation device with which the friction brake lining can be pressed for braking against a brake body to be braked,
a ramp mechanism that extends at an angle to the brake body and that braces the friction brake lining on being pressed against the brake body, the friction brake lining being supported displaceably on the ramp mechanism by roller bodies, and
a positive controller for the roller bodies, which prevents the roller bodies from leaving their raceways.

17. The friction brake in accordance with claim 16, wherein the positive controller comprises means preventing sliding of the roller bodies.

18. The friction brake in accordance with claim 16, wherein the positive controller comprises an end stop for the roller bodies, which end stop restricts the travel of the roller bodies.

19. The friction brake in accordance with claim 16, wherein the positive controller comprises means positively moving the roller bodies upon a displacement of the friction brake lining.

20. The friction brake in accordance with claim 19, wherein the positive controller comprises a gear wheel meshing with a rack, and wherein the gear wheel is connected or fixed to a roller body and the rack is connected or fixed to the friction brake lining.

21. The friction brake in accordance with claim 20, wherein the gear wheel meshes with two racks, one rack being connected to the friction brake lining and the other being fixed.

22. The friction brake in accordance with claim 16, further comprising a roller body cage joining the roller bodies, or a group of roller bodies together, the roller body cage keeping the roller bodies at their spacing from one another and in their position relative to one another.

23. The friction brake in accordance with claim 22, wherein the positive controller engages the roller body cage.

24. The friction brake in accordance with claim 16, wherein at least one roller body guides the friction brake lining transversely to its displacement direction in a statically determined way.

25. The friction brake in accordance with claim 24, wherein two roller bodies guide the friction brake lining transversely to its displacement direction in a statically determined way; and wherein further roller bodies guide the friction brake lining nontransversely to its displacement direction.

26. The friction brake in accordance with claim 24, wherein the roller body is a ball, which is guided in two diametrically opposed spherical channels, and which in each spherical channel is located at two points, one on each side of an imaginary lowermost line of the spherical channels.

27. The friction brake in accordance with claim 24, wherein the roller body is a roller disposed with an inclination transversely to a displacement direction of the friction brake lining.

28. The friction brake in accordance with claim 27, wherein the friction brake comprises at least two rollers as roller bodies, whose inclinations are counter to one another.

29. The friction brake in accordance with claim 28, wherein the friction brake has three rollers as roller bodies, the three rollers being located at the corners of an imaginary triangle, and the inclinations of radially inner rollers are counter to the inclinations of a radially outer roller.

30. The friction brake in accordance with claim 16, wherein the friction brake is a partly lined disk brake.
